(19) United States
(12) Patent Application Publication
(10) Pub. No.: US 2009/0327487 A1
(43) Pub. Date: Dec. 31, 2009

(54) METHOD AND SYSTEM FOR DISCOVERING DNS RESOLVERS

(76) Inventors: Eric Olson, Alexandria, VA (US); Greg Ogorek, Ashburn, VA (US)

Correspondence Address: DLA PIPER LLP US, P. O. BOX 2758, RESTON, VA, 20195, US

(21) Appl. No.: 12/481,897

(22) Filed: Jun. 10, 2009

Related U.S. Application Data
(60) Provisional application No. 61/076,870, filed on Jun. 30, 2008.

(51) Int. Cl. G06F 15/173

(52) U.S. Cl. 709/224

(57) ABSTRACT

A system and method for proactively discovering DNS resolvers in a network, comprising: sending IP addresses in the network to a scanning application; directing the scanning application to query each computer that corresponds to each IP address for information indicating whether each computer is a DNS resolver or a non DNS resolver; and identifying each computer as a DNS resolver or a non DNS resolver based on the information.

### CROSS-REFERENCE TO RELATED APPLICATION

This application is based on and derives the benefit of the filing date of U.S. Provisional Application No. 61/076,870, filed Jun. 30, 2008, which is herein incorporated by reference in its entirety.

### BRIEF DESCRIPTION OF THE FIGURES

FIG. 1 is a graphical representation of a Domain Name System (DNS) query resolution.

FIGS. 2-4 and 7 illustrate a system and method for discovering DNS resolvers and indicating whether the DNS resolver are resolving domain names to incorrect addresses, according to several embodiments.

FIGS. 5-6 are user interfaces for a system and method for discovering DNS resolvers and indicating whether the DNS resolvers are resolving domain names to incorrect addresses, according to several embodiments.

### DESCRIPTION OF EMBODIMENTS OF THE INVENTION

Useful for several reasons, DNS makes it possible to attach easy-to-remember hostnames (such as “cyveillance.com”) to hard-to-remember IP addresses (such as 38.100.19.13). The DNS is a hierarchical system by which hosts On the Internet can have both domain name addresses (such as cyveillance.com) and. IP addresses (such as 38.100.19.13). The domain name address can be used by human users, who can recite and remember URLs and email addresses that can be automatically translated into the numerical IP address, which can be used by packet-routing software. In providing a worldwide redirection service, DNS helps make widespread Internet use by non-technical users possible.

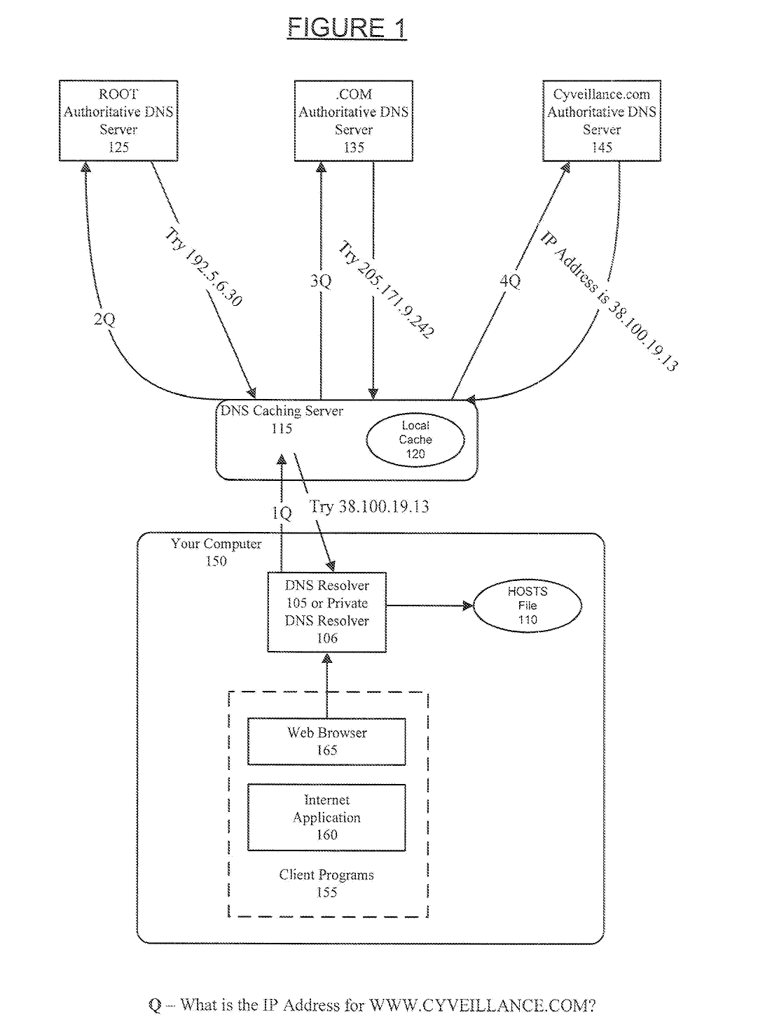

DNS resolution can take place transparently in applications such as Web browsers, email applications, and other Internet applications. Referring to FIG. 1, a computer 150 has several client programs 155., including Web browser 165 and/or Internet application 160. When a request is made which necessitates a DNS lookup, such programs send a resolution request to local DNS resolver 105, which handles the communications required to resolve a hostname to an IP address.

The local DNS resolver 105 can first look up the IP address in a hosts file 110 (i.e., a file in most operating systems which has a mapping between domain names and the corresponding IP addresses to find the IP address that corresponds to a given domain name). If the answer is not found in the hosts file 110, the local DNS resolver 105 can send the resolution request to a designated DNS caching server 115. For many home users the DNS caching server 115 is hosted by their ISP. Some businesses or entities also use DNS caching servers 115 hosted by their ISPs. Other businesses or entities host and administer their own DNS caching servers 115.

The DNS caching server 115 looks in its local cache 120 to see if it has the answer for the resolution request. For performance, scalability, and other reasons, DNS caching servers can cache the answer of recent DNS queries in the local cache 120. If the answer is not found in the local cache 120, the DNS caching server can query an authoritative DNS server, which is authoritative for a certain domain. This information is obtained by the DNS caching server 115 by traversing the DNS hierarchy for that domain starting at the root DNS server 125. For example; to resolve www.cyveillance.com, the DNS caching server will query the authoritative DNS server 125 for the root. If the root authoritative DNS server 125 does not know the IP address for www.cyveillance.com, it will tell the DNS caching server 115 who to query to find this answer. In this example, the root authoritative DNS server 125 indicates that IP address 192.5.6.30 may know the IP address for cyveillance.com. The DNS caching server 115 can then query IP address 192.5.6.30, which is the .com authoritative DNS server 135, to resolve cyveillance.com. If the .com authoritative DNS server 135 does not know the requested IP address for cyveillance.com, it can indicate that IP address 205.171.9.242 may know the IP address for www.cyveillance.com. The DNS caching server 115 will then query IP address 205.17.1.9.242, the www.cyveillance.com authoritative DNS server 145, which knows that the IP address of the host www.cyveillance.com is 38.100.19.13. Subsequent queries for this hostname to the DNS caching server 115 can be immediately resolved by the cached answer in the local cache 120 until the cached answer expires, as determined by, for example, a time-to-live (TTL) attribute of the cyveillance.com domain set by the DNS administrator of that domain.

The DNS described in FIG. 1 is a highly distributed lookup mechanism analogous to the traditional phone book. The DNS matches each domain name with its corresponding numerical address. Millions of copies of the match of a domain name with its corresponding numerical IP address are stored on computers worldwide so that any user anywhere has a nearby resolver that can answer each inquiry in a timely fashion.

The DNS, however, can diverge from the “phone book” metaphor. For the phone book, there can be a single authoritative publisher that knows and distributes the knowledge of what name corresponds to what numerical address. The DNS can operate differently. As explained with respect to FIG. 1, it is the owner of each domain name that provides the information about the numerical IP address that corresponds to that domain name. Thus, for example, the owner of cyveillance.com is the entity that would provide information that the IP address for cyveillance.com is 38.100.19.13. This information is then propagated rapidly across the DNS so that when, for example, the IP address is changed by the owner of the domain name, millions of copies of the “phone book” around the world are given the updated information in a matter of hours.

The DNS infrastructure can be attacked in order to poison information about which domain names correspond to which numerical IP addresses. For example, some copies of the “phone book” (e.g., analogous to the DNS Resolver 105) can be given substitute IP addresses for a specific domain name, resulting in that domain name resolving to content and a machine that is not the true Web site operated by the owner of the domain name. As a result, an Internet user could, for example, type “www.MyBank.com” in a browser, and be pointed at an exact copy of the bank's Web site on a malicious duplicate web site, so the login, password or other confidential information entered on that site would be received not by the bank but by a criminal operating the malicious duplicate of the bank's Web site. Because the domain name shown in the browser and entered by the user is the correct domain name, the user may have no way of knowing the site they were visiting was a fraudulent fake. This practice of surreptitiously pointing a domain name at an incorrect IP address for the purpose of fraud or other illegitimate reasons is often called “pharming”.

There are several technical ways this “hijacking” of the DNS resolution process can happen. Those of ordinary skill in the art will see that the DNS resolution process can be “hijacked” in many ways. For example, the “hijacking” can involve hacking a legitimate DNS resolver 105 and replacing a correct IP address with an incorrect IP address.

The DNS resolution process can also be “hijacked” by pointing the Web browser or other program to a private DNS resolver 106 instead of the DNS resolver 105. The private DNS resolver 106 can be completely detached from the publicly managed DNS network. These private DNS resolvers 106 can be populated with domain name-IP address pairs containing incorrect IP addresses for one or more domain names the criminal or perpetrator would like to resolve to an address other than the IP address that the domain owner intends. For example, a private DNS resolver 106 could contain tens of millions of name-address pairs, and, if queried, could provide the correct answer for all but one of those names, e.g. www.MyBank.com.

To leverage the private DNS resolver 106 disconnected from the public DNS infrastructure, a user's computer can be modified or instructed to utilize the improper, private DNS resolver 106 to resolve domain names instead of the appropriate DNS resolver 105 it would normally use when operating correctly. Due to the complexity of the software installed on a computer, modification of the system to use a private DNS resolver 106 can be accomplished by many methods. Four example methods are illustrated below. Those of ordinary skill in the art will see that many other methods may also be used. In the first example method, an individual user's computer can be “hacked” or surreptitiously accessed from the outside, and the local HOSTS file can be overwritten, or the other browser or system settings can be modified to ensure the computer uses the improper, private DNS resolver. In a second example, the user's computer can also be infected with a malicious program that changes the necessary files or settings automatically to accomplish these same system changes. These malicious programs can be installed automatically and invisibly on a user's computer whenever certain malicious Web pages are visited. Alternatively, they can be installed manually by a user who has been tricked into accepting a malicious download. For example, one technique involves creating Web sites that use the lure of free pornographic videos, but when the user tries to watch the videos, they are told they need a special program to view the content. The user voluntarily accepts a download of what they believe is a simple video viewer but is actually a malicious program. A third example method can involve similar “social engineering” or trickery that leads the user into changing the settings voluntarily (e.g. with the promise of money, pornography or other desired result). A fourth example method can involve the installation of a generic piece of malicious software such as a “trojan downloader” or “backdoor” which makes the computer permanently accessible to a criminal or hacker at will. Once such a program is installed on the computer, a criminal may be able to access, modify or control the computer from a remote location at any time, allowing the criminal to instruct the computer to use the private DNS resolver, and/or any other malicious changes to the computer that the criminal desires. This is a particularly dangerous variant since it means even if the user manages to reset or change the settings back to normal, the machine can be re-accessed at will and reconfigured repeatedly for all kinds of illicit uses.

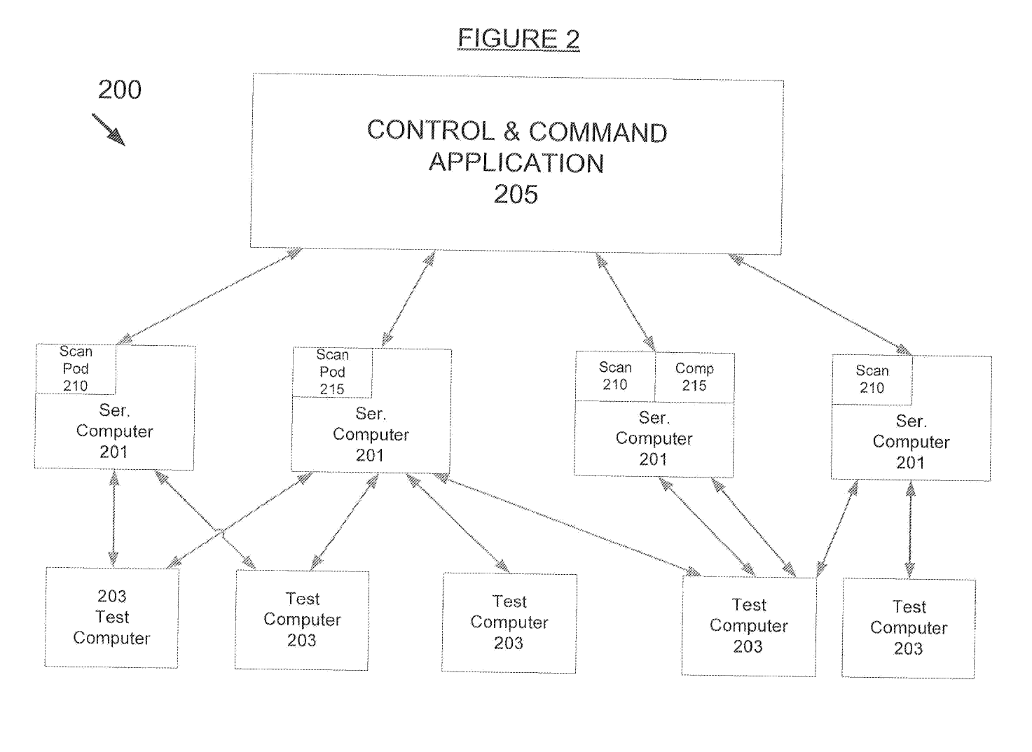

FIG. 2 illustrates a system 200 that discovers the presence of DNS resolvers (105 and/or 106), according to one embodiment. The system 200 can also indicate that the DNS resolvers (105 and/or 106) are resolving domain names to incorrect IP addresses. FIG. 2 illustrates a Command and Control application 205 that utilizes and communicates with one or more serialized computers 201 that utilize a Scan Proactive Observation of DNS (Scan POD) application 210 to scan test computers 203. (It should be noted that, in one embodiment, the Scan POD application may be installed on the same computer as the Command And Control application 205). Each test computer 203 is located at an IP address that the Command and Control application 205 desires to check to see if the test computer 203 is acting as a DNS resolver. The serialized computers 201 can each have the Scan POD application 210 installed and can work together to scan many test computers 203, as each serialized computer can scan a certain block of test computers 203. In one embodiment, the serialized computers 201 can be dedicated machines operated by the owner of the system (trusted or owned servers). In another embodiment, the Scan POD application 210 can be installed on many non-owned computers in order to distribute the work over a large base of voluntarily employed machines. For example, the operator of the system could offer an incentive to Internet users such as payment, information, recognition or services, in return for which the users would voluntarily install the Scan POD application 210 on their computers. The result under this model would not be a small number of operator-owned serialized computers 201, but a massive distributed network of volunteered machines contributing to data collection from points all over the world. (Note that the Compare POD application 215, described below, can also be installed using these embodiments.) The serialized computer 201, whether operator-owned or distributed volunteer machines, uses the Scan POD application 210 to determine if the test computers 203 are DNS resolvers. The serialized computers 201 can take a block or range of IP addresses (e.g. 192.168.1.1,192.168.1.2, etc.), or a range of a range (e.g., 192.168.1.0/24, 10.10.0.0/16), and systematically work through the entire range of IP addresses, asking the test computer 203 corresponding to each IP address to resolve one or more DNS lookup requests. For each test computer 203 that responds in the affirmative (e.g., by resolving at least one DNS lookup request), that test computer 203 is, in essence, saying “Yes, I am acting as a DNS resolver”. The identity of those test computers 203 that are found to be DNS resolvers are then communicated back to the Command-and-Control application 205. The Command-and-Control application in turn provides lists of those test computers 203 that are acting as DNS resolvers to the same or a different set of serialized computers 201 that run another software application module, the Compare POD application 215. The Compare POD application 215 sends queries to the test computers 203 that were found by the Scan POD applications 210 to be DNS resolvers. The queries ask the test computers 203 to look up one or more predetermined domain names. The IP addresses returned by the test computers 203 that are DNS resolvers are then compared against one or more expected or definitively correct IP addresses (e.g., the known legitimate IP address of a certain domain name according to the owner of that domain such as a bank). Test computers 203 where the returned IP address does not match one of the expected or known allowable IP address are communicated back to the Command-and-Control application 205, where they are flagged or alerted for investigation or follow up.

A Command and Control application 205 can be accessed via a user interface such as a Web-based control panel. The Command and Control application 205 can monitor and control all aspects of the system 200, including, but not limited to: dispatching to the serialized computers 201 assigned IP addresses (e.g., an IP address range, specific IP addresses) to query using the Scan POD application 210; and recording, monitoring, and managing the flow of the returned Scan POD results; dispatching to the serialized computers 201 Scan POD results that are DNS resolvers to be checked by a Compare POD application 215; recording, monitoring, and managing the flow of the returned results; cataloging anomalous results and specifying test computers 203 to investigate further; preparing alerts and investigative data; and managing the display and reporting of all processes and information to the user interface.

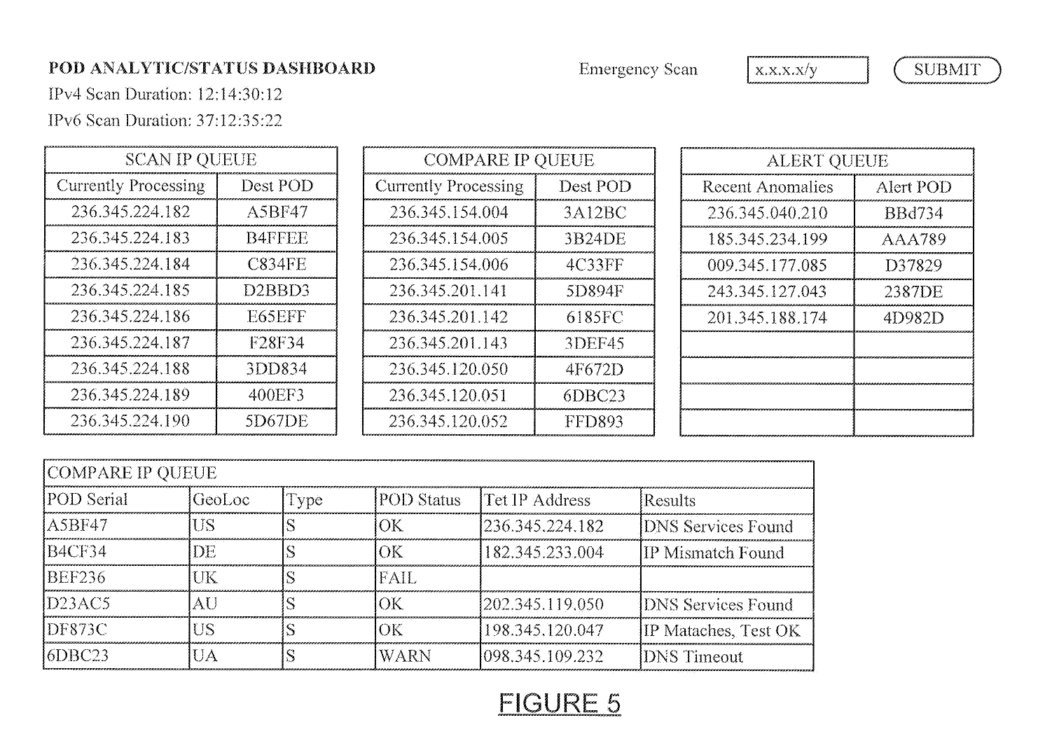

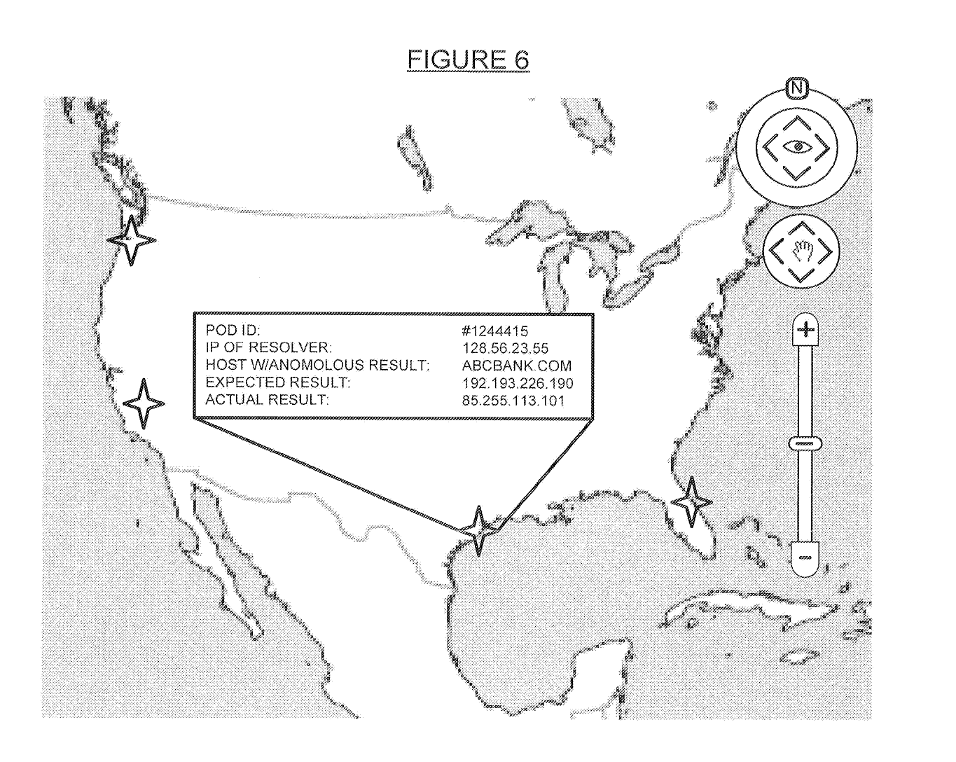

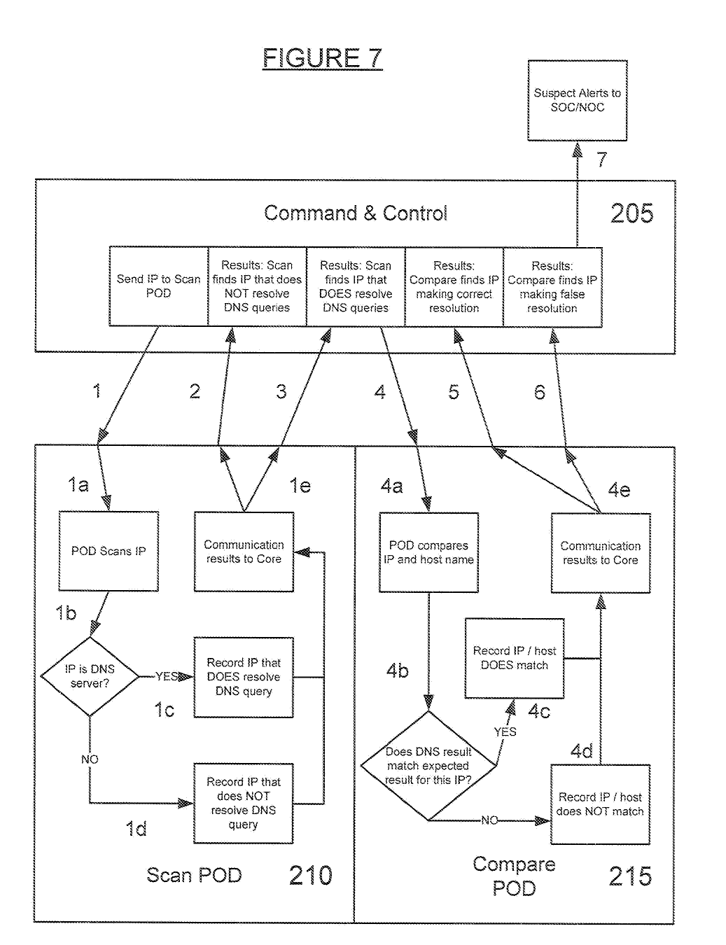

FIG. 5 illustrates a user interface that can display and manage information in a variety of ways, according to one embodiment. In one possible implementation, as shown in FIG. 5, one screen could provide a “dashboard” view of the flows of traffic through each of the principal processes. Portions of the screen would reflect the flow of IP addresses or blocks of addresses and the results for those IP addresses, to and from the individual POD machines conducting the Scan and Compare activities. Another screen or section of this same interface could monitor the status, operational health and current IP's being processed on each individual POD machine. In a second possible implementation, as shown in FIG. 6, the relevant activities of the entire POD network could be geographically represented on a map or globe. Moving, illuminated points could be used to show the dispatch and return of blocks of IP addresses to POD machines geographically dispersed all over the world, or colored icons could be used to indicate the geographic location of an IP address when a Compare POD discovers an anomalous result. These on-screen icons could become mouse-clickable on-screen items that, when clicked, display the IP, physical location of the machine, and the name(s) that were incorrectly resolved or other relevant data points. These are just two possible embodiments for visualizing the data and allowing user-friendly status reporting and network control for a highly complex system via the Command and Control application 205. Those of ordinary skill in the art will see that many other embodiments are possible.

The Command and Control application 205 can also contain traffic management components to manage the order, assignment and scheduling of each Scan POD application 210 and Compare POD application 215, what IP ranges each Scan POD application 210 or Compare POD application 210 investigates, when each discovered resolver computer is contacted, etc. It should be noted that the Scan POD application 210 and the Compare POD application 215 can be run on the same serialized computer 201, or on different serialized computers 201. In addition, the Scan POD application 210 and the Compare POD application 215 can be run on the same serialized computer 201, but each POD can test different IP addresses corresponding to different test computers 203. This can be done to minimize the visible “footprint” of the scanning and comparing activities to minimize the chance that the scanning and comparing activities tip off malicious users to the fact that they have been discovered. A wide variety of other methods can also be used to minimize the visible footprint left by the scan and compare activities. Examples include, but are not limited to: taking the entire list of IP addresses to be scanned and assigning each one a random 10-digit number, then scanning the list in order of the random number assigned to each target IP address; mathematically ensuring that no significant number of sequential addresses could possibly remain in close proximity in the list; or programming rules into each scanning pod that forbid querying any two IP addresses in the same netblock less than a certain number of seconds apart. Those of ordinary skill in the art will see that many other methods can be used.

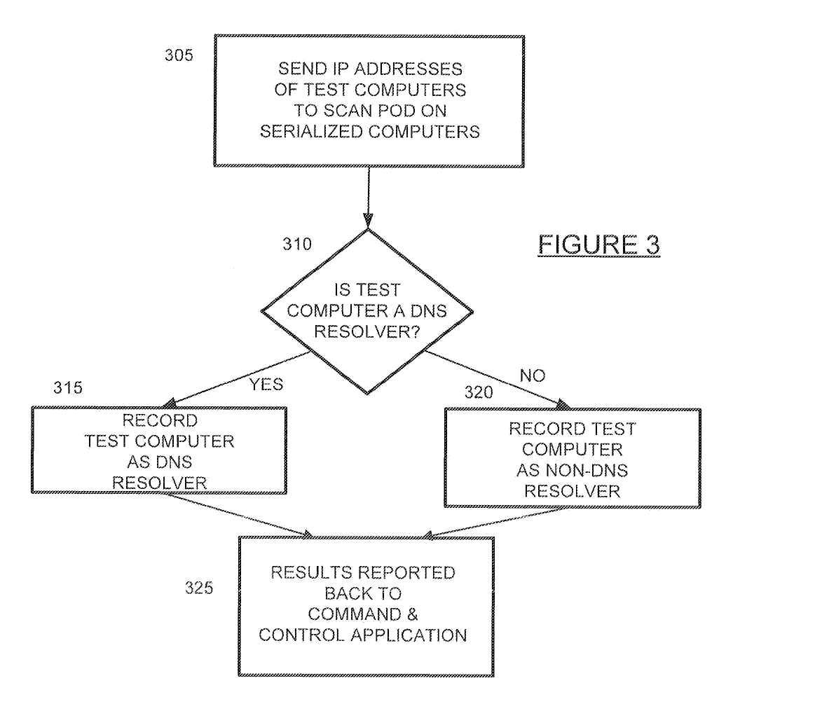

FIG. 3 illustrates a method that can discover the presence of a DNS resolver (105 and/or 106), according to one embodiment. In 305, the Command and Control application 205 can send a block of IP addresses to the Scan POD application 210 on a serialized computer 201. In 310, the Scan POD application 210 tests the IP addresses of test computers 203 for the availability of DNS resolution services. For example, the Scan POD application 210 can see if the test computer 203 will, when queried with a domain name (e.g., cyveillance.com), return an IP address. If yes, this confirms the test computer 203 is acting as a DNS resolver. In 315, if the test computer 203 resolves the request, the Scan POD application 210 module records that positive result. In 320, if the test computer 203 doesn't resolve the request (e.g., if no response is returned or an error message is returned), the Scan POD application 210 records that as a negative result. IP addresses that don't resolve right away can be recorded as a negative result. In 325, the positive and negative results are reported back to the Command & Control application 205.

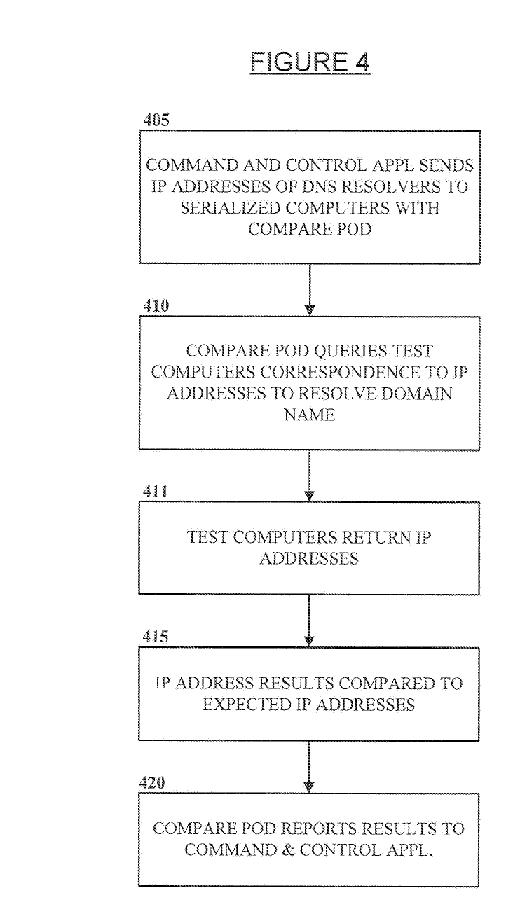

FIG. 4 illustrates a method that can demonstrate that a DNS resolver (105 and/or 106) is resolving domain names to incorrect IP addresses, according to one embodiment. In 405, the Command & Control application 205 can send a block of IP addresses corresponding to test computers 203 known (from the process illustrated in FIG. 3) to be DNS resolvers to a serialized computer 201 with the Compare POD application 215 installed. In 410, the Compare POD application 215 can query the test computers 203 that are DNS resolvers with various domain names to see what IP addresses are returned. The various domain names can correspond to domain names of interest (e.g., domain names that are known to have problems), domain names of entities that wish to have their domain names monitored, etc. In 411, the test computers 203 that are DNS resolvers return IP addresses. In 415, these live lookup IP address result can be compared with expected IP addresses for the domain names. In 420, the Compare POD application 215 can report to the Command and Control application 205 whether or not the live lookup results for the IP addresses match the expected results. (Note that in one embodiment, the Compare POD application 215 can only report if the live lookup results for the IP addresses do not match the expected results.) Results of IP addresses matching correct resolutions can be stored by the Command & Control application 205 for future scanning or analysis. In other words, the receipt of expected values does not permanently exclude that IP address from future investigation, it simply indicates that no problem was detected at this time, and the IP should be catalogued as a live DNS resolver. In one embodiment, the test computers 203 that return IP addresses not matching expected results can be immediately reported. In another embodiment, all results can be reported at the same time, or at certain pre-designated intervals. The test computers 203 that return IP addresses not matching expected results can be sent to a Network Operations Center or Security Operations Center for further analysis and processing. For example, the system can send alerts to, or otherwise notify, the operator of the Command-and-Control application 205, or the Internet Service Provider in whose netblock the rogue resolver was found, or an appropriate third-party security company, or the owner of the Web site being incorrectly resolved, or a government or law-enforcement agency, and/or any other entity. This message or communication can alert the recipient that a certain DNS resolver has been demonstrably found conducting unauthorized or incorrect DNS resolutions and/or could include any other pertinent information related to the discovery.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments.

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6.

1. A method for proactively discovering DNS resolvers in a network, comprising:
sending IP addresses in the network to at least one scanning application;
directing the at least one scanning application to query each computer that corresponds to each IP address for information indicating whether each computer is a DNS resolver or a non DNS resolver; and
identifying each computer as a DNS resolver or a non DNS resolver based on the information.

2. The method of claim 1, wherein all DNS servers in the network are queried and/or wherein all DNS resolvers in the network are discovered.

3. The method of claim 1, wherein public DNS resolvers and/or private DNS resolvers are identified.

4. The method of claim 1, wherein the IP addresses sent to the at least one scanning application are a block of IP addresses and/or a block of a block of IP addresses.

5. The method of claim 1, wherein each computer is queried in a manner that avoids counter-detection.

6. The method of claim 1, wherein the at least one scanning application queries the IP addresses in an order and/or a timeliness that avoids counter-detection.

7. The method of claim 1, further comprising:
directing at least one comparing application to query each DNS resolver for information indicating whether each DNS resolver relates at least one domain name to at least one inaccurate IP address.

8. The method of claim 1, wherein the at least one scanning application and/or the at least one comparing application are installed on multiple computers.

9. The method of claim 8, wherein the at least one scanning application and the at least one compare application are installed on the same computer.

10. The method of claim 8, wherein the at least one scanning application and the at least one compare application are installed on different computers.

11. A system for proactively discovering DNS resolvers in a network, comprising:
a server coupled to a network;
a database accessible by the server; and
an application coupled to the server, the application configured for:
sending IP addresses in the network to at least one scanning application;
directing the at least one scanning application to query each computer that corresponds to each IP address for information indicating whether each computer is a DNS resolver or a non DNS resolver; and
identifying each computer as a DNS resolver or a non DNS resolver based on the information.

12. The system of claim 11, wherein the application is further configured so that all DNS servers in the network are queried and/or wherein all DNS resolvers in the network are discovered.

13. The system of claim 11, wherein the application is further configured so that public DNS resolvers and/or private DNS resolvers are identified.

14. The system of claim 11, wherein the application is further configured so that IP addresses sent to the at least one scanning application are a block of IP addresses and/or a block of a block of IP addresses.

15. The system of claim 11, wherein the application is further configured so that each computer is queried in a manner that avoids counter-detection.

16. The system of claim 11, wherein the application is further configured so that at least one scanning application queries the IP addresses in an order and/or a timeliness that avoids counter-detection.

17. The system of claim 11, wherein the application is further configured for:
directing at least one comparing application to query each DNS resolver for information indicating whether each DNS resolver relates at least one domain name to at least one inaccurate IP address.

18. The system of claim 11, wherein the at least one scanning application and/or the at least one comparing application are installed on multiple computers.

19. The system of claim 18, wherein the at least one scanning application and the at least one compare application are installed on the same computer.

20. The system of claim 18, wherein the at least one scanning application and the at least one compare application are installed on different computers.
